(19) United States
(12) Patent Application Publication
(10) Pub. No.: US 2025/0166520 A1
(43) Pub. Date: May 22, 2025

(54) SYSTEM AND METHOD FOR CENTRALLY MANAGING ADAPTIVE LEARNING ACROSS MULTIPLE DISTRIBUTED E-LEARNING EXPERIENCES

(71) Applicant: The Ontario Educational Communications Authority (TVO), Toronto (CA)

(72) Inventor: Owen LAMBERT, Toronto (CA)

(73) Assignee: The Ontario Educational Communications Authority (TVO), Toronto, ON (CA)

(21) Appl. No.: 18/512,994

(22) Filed: Nov. 17, 2023

(51) Int. Cl. G09B 5/00; G06N 5/02

(52) U.S. Cl. CPC G09B 5/00; G06N 5/02

(57) ABSTRACT

A system configured for at least one content producer to generate adaptive e-learning experiences for a plurality of learners, the system comprising: at least one memory device configured for storing instructions; and at least one processor coupled to the at least one memory device and configured to execute the instructions to at least: access a graph database storing a learner knowledge graph comprising an ontology for a plurality of learning topics; develop content comprising at least one course material associated with one of the plurality of learning topics, wherein the content comprises a learning section; and wherein the content is associated with at least one learner experience type; distribute the at least one course material in accordance with a selected e-learning experience, herein the content within each learning section is tagged with one of the plurality of learning topics suited for the e-learning experience; track learning events generated by the plurality of learner, wherein the learning events comprise at least one of viewing and interaction activities related to content consumption and learner validation activities; generate learner event data from the learning events; anonymize the learner event data; share the learner event data with another at least one content producer; based on the learner event data, determine an effectiveness quotient of the content for teaching the course material.

### FIELD

The present disclosure relates to methods and systems for e-learning.

### BACKGROUND

Generating and providing truly portable and accessible online content is a challenge in the e-learning industry. There exist standards for development of accessible e-learning, such as the World Wide Web Consortium's (W3C) Web Content Accessibility Guidelines (WCAG 2.0), Authoring Tool Accessibility Guidelines (ATAG 2.0), and Accessible Rich Internet Application (ARIA 1.0) specification. However, these standards are deficient in addressing the challenges associated with accessible content development, especially the economic challenges with developing online content that fully meets the needs of the students or learners not just in e-learning, but in all areas of online content management.

Several solutions have been proposed to tackle this problem in the four sectors in the educational content space, such as learning management systems (LMS), online, authoring tools/content management systems, education providers, and learning content management systems (LCMS). Generally, learning management systems are closed environments where students study, are assessed, and actively interact with one another. These systems are analogous to online classrooms. Example products include Blackboard® from Anthology Inc., U.S.A., Instructure® by Canvas Inc., U.S.A., Schoology® from PowerSchool Group LLC, U.S.A., Brightspace® from D2L Corporation, Canada (and open-source solutions like Moodle® and Sakai®. Online education providers are also closed ecosystems of independent learning, and example products include Pluralsight Skills®, LinkedIn® Learning, Coursera®, Udemy®, Udacity®, and Masterclass®. Authoring tools or content management systems comprise software and services that authors, such as web developers, designers, writers, etc., can use to produce and manage web content e.g., static web pages, dynamic web applications, for websites, blogs, media, and ecommerce-style sites. Example products of authoring tools or content management systems include Shopify®, Wix®, Weebly®, Progress Sitefinity®, Squarespace®, and Open-Source solutions e.g. WordPress® and Drupal®. Learning content management systems are used to develop course content for either distribution to LMSes or direct consumption directly by students or learners. Example LMS products include Top Hat®, Articulate®, Turning®, and Lectora®.

With respect to the authoring tools, accessibility support in the market today is focused on functionality that is best reflected by the W3C's Authoring Tools Accessibility Guidelines (ATAG) which define how to make the authoring tools themselves accessible, such that people with disabilities can create web content, and help authors create more accessible web content, specifically: enable, support, and promote the production of content that conforms to WCAG. These guidelines reflect an approach to content contained in these tools that assumes that the consumer will consume web content; and that the primary consumer of the content is an enabled person and that the point of the guidelines are to make the authoring tool provide a minimal level of accessibility support for disabled persons looking to consume this enabled person intended content.

At present, the market expectation for content development is designed to gracefully degrade the content experience, such that the most enabled consumers experience the content as intended, and the experience degrades for less enabled consumers in such a manner as it is designed to minimize the breaking of the experience for the less enabled consumers. For example, a content producer will for example record and make available a video which is best-suited to or provides the richest experience to fully enabled consumers i.e. those without disabilities, then add closed captioning and/or described video etc. to express what is in the video for the visually impaired. The challenge here is that from a learning perspective the nuance of the actual learning is designed around a visual experience that often does not translate fully to the transcription as the language prioritizes the description of the video content instead of the learning concepts. This methodology applies to most content that is produced by these existing systems whereby the primary intended audience is a fully enabled user with a desktop computer or a tablet such that fully enabled user enjoys the best experience, while the experience is degraded for individuals with accessibility, equity, or device challenges.

As such, none of the products on the market today provide for the broader portability and accessibility needs of e-learning content producers (course publishers, educational institutions, and governments/educational ministries) to develop and manage content effectively from an accessibility-first perspective while also providing rich, highly engaged interactive experiences for fully enabled users.

Furthermore, the ability to effectively build e-learning content that is adaptive learning-enabled and adaptive teaching-enabled is historically challenged by the ability of content authors to effectively manage the metadata tagging and knowledge graph management requirements for organizing that content. The present technology space does not address or even attempt to address this problem. There exist some adaptive learning products, however, most work in the space outside of proprietary closed content ecosystems (e.g., Coursera™, Khan Academy™, etc. type organizations) is related to three areas: tutoring platforms, chat bots, and automated assessment engines. Furthermore, academia has been focused and has shown great effectiveness on researching and developing the effectiveness of learning algorithms as opposed to the content production and organization. There are no known content development platforms designed explicitly to simplify the data classification problem of adaptive learning by organizing the content into knowledge components (learning topics) in an authoring experience. For example, adaptive learning exists in tutoring platforms today such as ALEKS™ and Knewton™, as well as in CMSes such as SmartSparrow™ and Top Hat™. However, these products do not provide the unique functionality to solve for the content classification and authorship challenges to make adaptive learning content development effective. Additionally, no products are explicitly designed to leverage multi-client scaling through the universal classification and shared ontology this content classification represents as a means of standardizing and streamline the effectiveness of adaptive learning algorithms.

Generally, adaptive learning and adaptive teaching have not been implemented successfully, except in limited closed environments in the education sector, largely because the content is being only organized into non-discreet elements, such as lessons, that contain numerous learning topics within them. The inability to easily modularize content into labelled sections that reflect these discrete learning topics has resulted in either unmanageable requirements for the effort to support the required content data classification that adaptive learning algorithms depend on, or the over dependence of automated classification systems to achieve this.

### SUMMARY

In one of its aspects, a system configured for at least one content producer to generate adaptive e-learning experiences for a plurality of learners, the system comprising:
at least one memory device configured for storing instructions; and
at least one processor coupled to the at least one memory device and configured to execute the instructions to at least:
   access a graph database storing a learner knowledge graph comprising an ontology for a plurality of learning topics;
   develop content comprising at least one course material associated with one of the plurality of learning topics, wherein the content comprises a learning section; and wherein the content is associated with at least one learner experience type;
   distribute the at least one course material in accordance with a selected e-learning experience, wherein the content within each learning section is tagged with one of the plurality of learning topics suited for the e-learning experience;
   track learning events generated by the plurality of learner, wherein the learning events comprise at least one of viewing and interaction activities related to content consumption and learner validation activities;
   generate learner event data from the learning events;
   anonymize the learner event data;
   share the learner event data with another at least one content producer;
   based on the learner event data, determine an effectiveness quotient of the content for teaching the course material.

In another example, a method for generating adaptive e-learning experiences for a plurality of learners by at least one content producer, with a processor coupled to at least one memory device storing instructions executable by the processor to at least perform the operations of:
accessing a graph database storing a learner knowledge graph comprising an ontology for a plurality of learning topics;
developing content comprising at least one course material associated with one of the plurality of learning topics, wherein the content comprises a learning section; and wherein the content is associated with at least one learner experience type;
distributing the at least one course material in accordance with a selected e-learning experience, wherein the content within each learning section is tagged with one of the plurality of learning topics suited for the e-learning experience;
tracking learning events generated by the plurality of learner, wherein the learning events comprise at least one of viewing and interaction activities related to content consumption and learner validation activities;
generating learner event data from the learning events;
anonymizing the learner event data;
sharing the learner event data with another at least one content producer;
based on the learner event data, determining an effectiveness quotient of the content for teaching the course material.

In another example, at a content producer, a computer readable medium storing instructions executable by a processor to generate adaptive e-learning experiences for a plurality of learners, wherein the instructions carry out the operations comprising:
accessing a graph database storing a learner knowledge graph comprising an ontology for a plurality of learning topics;
developing content comprising at least one course material associated with one of the plurality of learning topics, wherein the content comprises a learning section; and wherein the content is associated with at least one learner experience type;
distributing the at least one course material in accordance with a selected e-learning experience, wherein the content within each learning section is tagged with one of the plurality of learning topics suited for the e-learning experience;
tracking learning events generated by the plurality of learner, wherein the learning events comprise at least one of viewing and interaction activities related to content consumption and learner validation activities;
generating learner event data from the learning events;
anonymizing the learner event data;
sharing the learner event data with at least another content producer;
based on the learner event data, determining an effectiveness quotient of the content for teaching the course material.

In another example, a method for generating adaptive e-learning experiences for a plurality of learners by at least one content producer, comprising with a processor coupled to at least one memory device storing instructions executable by the processor to at least perform the operations of:
associating each of the e-learning experiences with a learning topic comprising at least one adaptive learning variable;
executing a first set of instructions to train an adaptive learning model on a schedule or on-demand;
inputting anonymized learner event data, scoring data and learner knowledge graph from the at least one content producer as training data;
training the adaptive learning model with the training data to optimize the at least one adaptive learning variable; and
updating the learner knowledge graph with the outputted optimized at least one adaptive learning variable.

Advantageously, methods and systems are provided for building e-learning content that are adaptive learning-enabled and adaptive teaching-enabled by allowing content authors to effectively manage the metadata tagging and knowledge graph management requirements for organizing the content in a structure that enables adaptive learning. The methods and systems support the real-time data processes necessary to support active adaptive learning experiences and scheduled data processes for handling big data and machine learning processes that continuously improve the system's effectiveness.

The systems and methods described herein allow for centrally and anonymously managing adaptive learning experiences across multiple learning environments. Generally, e-learning experiences are associated with various learning environments such as, but not limited to, learning management systems, online and offline web browsers, mobile apps, or offline print. These experiences are shared, and users are anonymously managed through a centralized data store and system. The systems and methods allow for the development and deployment of digital experiences across multiple clients and e-learning experiences that share the same learning topic or knowledge component. The authoring experience is designed to constrain and enforce the data classification of these learning topics to discrete and modular sections of the content. This constrained modularization of e-learning content enables shared artificial intelligence (AI) and/or machine learning (ML) benefits from the complete pool of users studying any materials of the system across multiple clients.

The systems and methods allow for creating learning content that is composed of mixed interactive and non-interactive experiences organized modularly around learning topics, which enables not only personalized learning experiences (adaptive learning) but also the capacity to repackage alternative learning experiences rapidly and conveniently. For example, a unit of a Math 9 course may be focused on financial literacy with a lesson covering the four learning topics of inflation, deflation, appreciation, and depreciation, and the content may be developed as a single lesson, tagging the appropriate sections of content with their associated learning topics. On completion the base experience that the author was building against would be the lesson that covers all four learning topics. However, in view of the modularity of the content classification, this content may also now be repackaged and distributed as an experience where each of the four parts is sent separately to the student or learner, in the form of a daily email message, for example. As such, the method and system not only enable adaptability for the complexity and depth of the learning, but also the modality of the eLearning content consumption.

To simply and modularize this sectioning effort the systems allow for a minimum of two types of content sections that all content must be contained within: descriptive sections and labelled learning sections. Descriptive sections are focused on content not intended to provide direct learning outcomes, such as introduction and summary sections of a lesson and learning sections are for grouping content into their respective learning topics by requiring inclusion of an overriding section learning topic label that corresponds with learning topics that represent nodes on a centrally shared “knowledge tree”.

Generally, the knowledge tree is intended to serve as the data layer for a shared service across all clients who will create content that is ready for machine learning activities that can benefit from the broader benefits of the large audiences that are anonymously shared across these clients. To enable this goal the ontology of the knowledge tree must be highly restrictive to ensure content produced by different clients on the same learning topic share the benefits of this cross-pollination. Therefore, this data is developed and stored in a graph database with an emphasis on upper ontology only, universally shared node structure, and highly restricted access to modify and expand the knowledge tree.

The systems and methods enable the generation of content that may be consumed in various formats well beyond “web content” by decoupling the content from its presentation and providing a reliable means of exporting the content in other output formats. While the systems and methods promote inclusive design, the content produced is equally consumable by disabled and enabled persons, more emphasis is placed on the needs of disabled persons, who are viewed as the primary consumer from an authorship perspective. The difference in approach is best reflected in the latest ATAG version at the time of writing (2.0) recommendation B.2.3.1 “Alternative Content is Editable (WCAG)”, where the guideline states that “if the authoring tool provides functionality for adding non-text content, then authors are able to modify programmatically associated text alternatives for non-text content”. The equivalent functionality for this recommendation in the system presented herein would recite “if the authoring tool provides functionality for adding text content, then authors will be able to modify programmatically associated non-text alternatives for the text content”. As an example, in the event that a video is to be added as part of the content, the system expects text content and provides the ability to include a video alternative to that text.

Generally, the systems and methods allow for the development of portable and deeply accessible online learning experiences that can simultaneously address numerous learning experiences from print experiences for users with device limitations, screen readers of students with accessible needs, internet limited or no internet students with computer or mobile devices, offline experiences for device and internet enabled users who prefer to save bandwidth, traditional means of consumption on variant learning management systems (Sharable Content Object Reference Model (SCORM)/xAPI), and live hosted experiences across variant learning management systems (new methodology). As such, the content is stored in a “headless” format, where the content and the presentation are separated, in which the content details are saved as metadata instead of code. The content is then transcompiled and exported for publication in a plurality of formats to address the variable learning formats needed to tailor experiences to accessibility-first.

The systems and methods described herein intentionally reverse this paradigm by designing the authoring experience that is primarily intended for the least enabled consumers first so that they can fully learn the material regardless of their disabilities or device limitations. The learning is then progressively enhanced with interactivity such that all users have the best learning experience to their inherent capabilities. Of note, this is not simply providing the faculty for alternative content, though aspects of it would apply, rather it is a complementary state of content where the content is shared among different experience states and edited in such a shared state. In other words, the system is not designed as a “print version” that is distinct from a “fully digital version”. Rather it is designed to manage content in a hybrid state between the variant experiences supported such that e-learning content producers (course publishers, educational institutions, and governments/educational ministries) can write and maintain content that facilitates numerous experiences and builds alternative content for more enabled learners.

The method and system endeavors to address a significant portion of the economic barriers with producing content of this nature by drastically reducing the overhead and complexity and fundamentally shifting the approach to content design.

### BRIEF DESCRIPTION OF THE DRAWINGS

FIG. 1 with partial views FIG. 1a-1h shows a tenant infrastructure for publication, versioning, distribution, and remote management of e-learning content for plurality of learner experience types;

FIG. 2a shows a top-level diagram of an overall system architecture for developing content for distribution in a plurality of learner experience types;

FIG. 2b shows a tenant real-time adaptive learning infrastructure;

FIG. 3 shows a flow chart outlining example steps for real-time adaptive learning;

FIG. 4 shows a tenants scheduled adaptive learning model training infrastructure;

FIG. 5 shows a flow chart outlining example steps for training adaptive learning models using the tenant real-time adaptive learning infrastructure;

FIG. 6 shows a portion of an authoring canvas with prompts for adding a descriptive section and a learning section;

FIG. 7 shows an example user-interface comprising an authoring canvas;

FIG. 8 shows a portion of an authoring canvas for selecting a learning topic within an ontology of a centrally shared knowledge graph;

FIG. 9 shows a portion of an authoring canvas for adding components to a learning topic; and

FIG. 10 shows a block diagram of an example of a machine upon which any one or more of the techniques (e.g., methodologies) discussed herein can be performed.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the invention in any way. Indeed, for the sake of brevity, certain sub-components of the individual operating components, and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Generally, methods and systems described herein pertain to a software-as-a-service (SaaS) application designed to address the publication, versioning, distribution, and remote management needs of e-learning content across multiple learning environments. A SaaS provider provisions the application and platform to customers or “tenants” of the system. Within a tenant, numerous types of users of the tenant's applications (the applications designed to publish, version, distribute, and manage the content) are possible, additionally learners using content produced by the system are also restricted to that tenant except when explicit permission to share or move primary data ownership has been applied (such as when a learner transfers to a new school).

The systems and methods described herein are configurable to build e-learning experiences that share the same learning topic, also known as a knowledge component, among multiple clients and e-learning experiences. This collection of learning topics form a shared ontology (or dictionary) that enables all tenants to share anonymized learning data and benefit from the system learning from this shared learner data set. This provides subsequent enhancement opportunities for adaptive learning experiences within each learner's e-learning experiences that would not be attainable in isolation with one another.

Generally, methods and systems described herein pertain to a software-as-a-service (SaaS) application designed to address the publication, versioning, distribution, and remote management needs of e-learning content across multiple learning environments. A SaaS provider provisions the application and platform to customers or “tenants” of the system. Within a tenant, numerous types of users of the tenant's applications (the applications designed to publish, version, distribute, and manage the content) are possible, additionally learners using content produced by the system are also restricted to that tenant except when explicit permission to share or move primary data ownership has been applied (such as when a learner transfers to a new school).

The systems and methods described herein are configurable to build e-learning experiences that share the same learning topic, also known as a knowledge component, among multiple clients and e-learning experiences. This collection of learning topics form a shared ontology (or dictionary) that enables all tenants to share anonymized learning data and benefit from the system by learning from this shared learner data set. This sharing allows for enhancing the adaptive learning experiences for each learner, which would not be attainable otherwise.

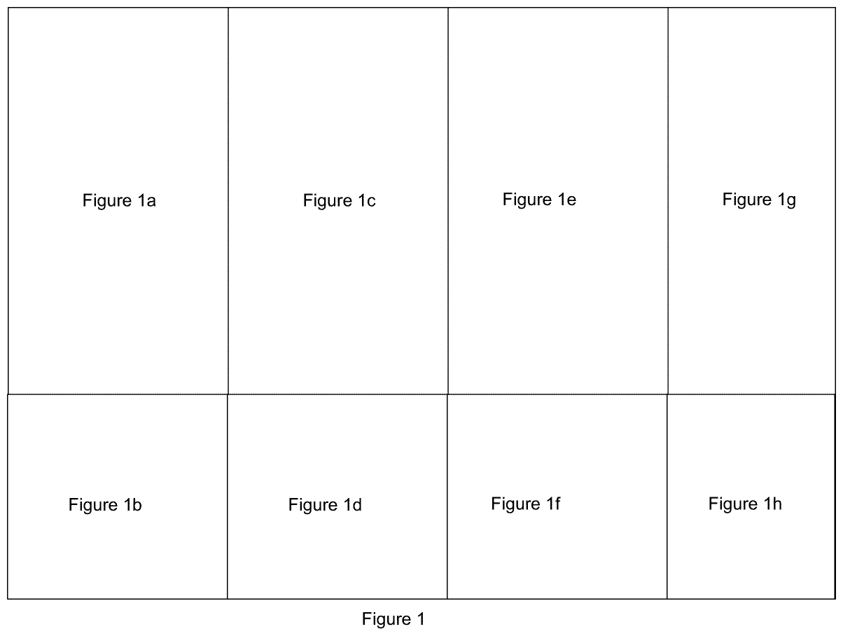

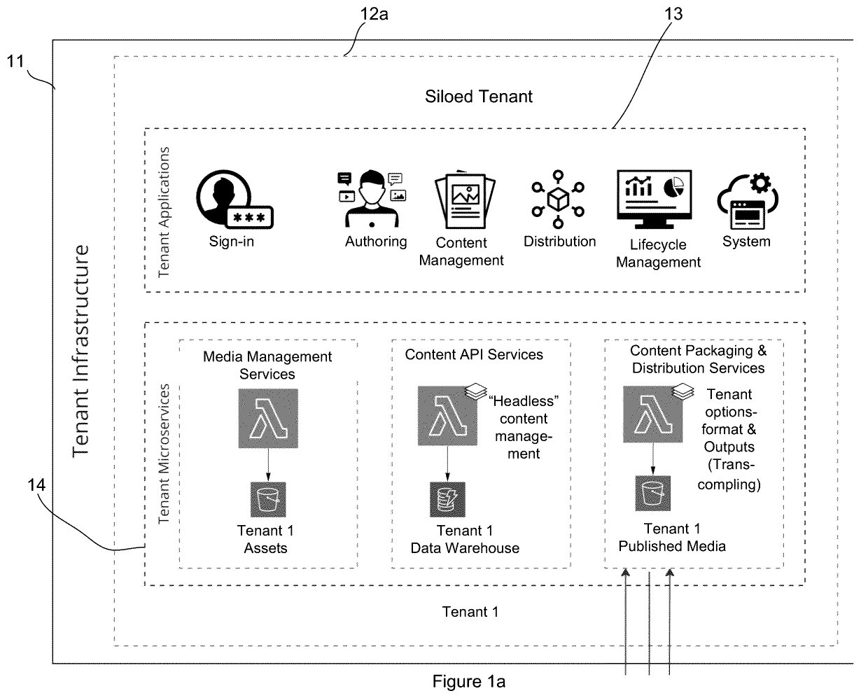

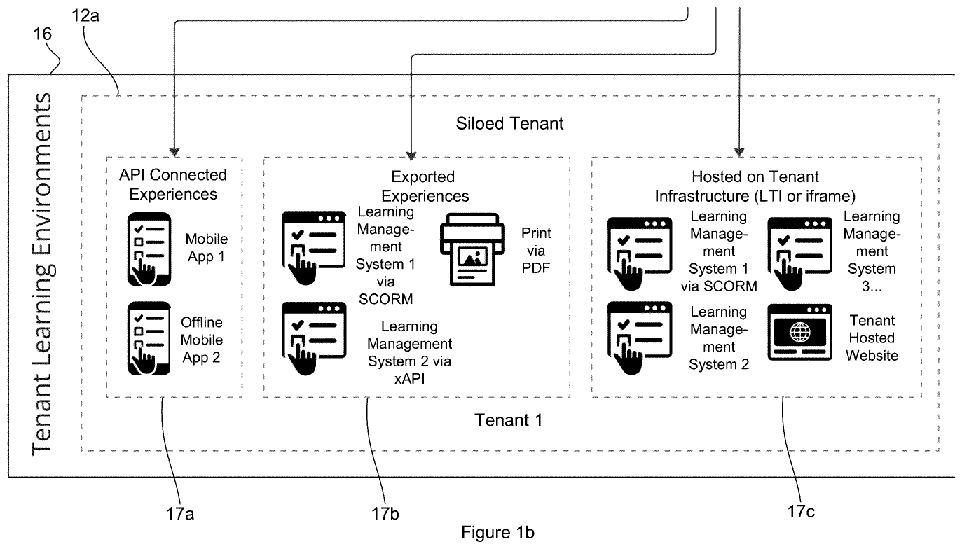

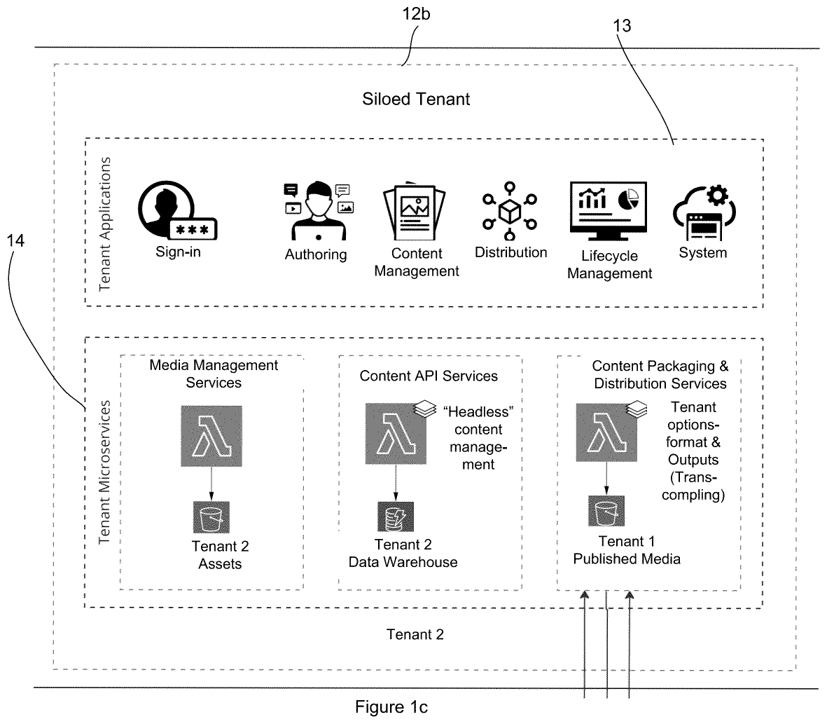

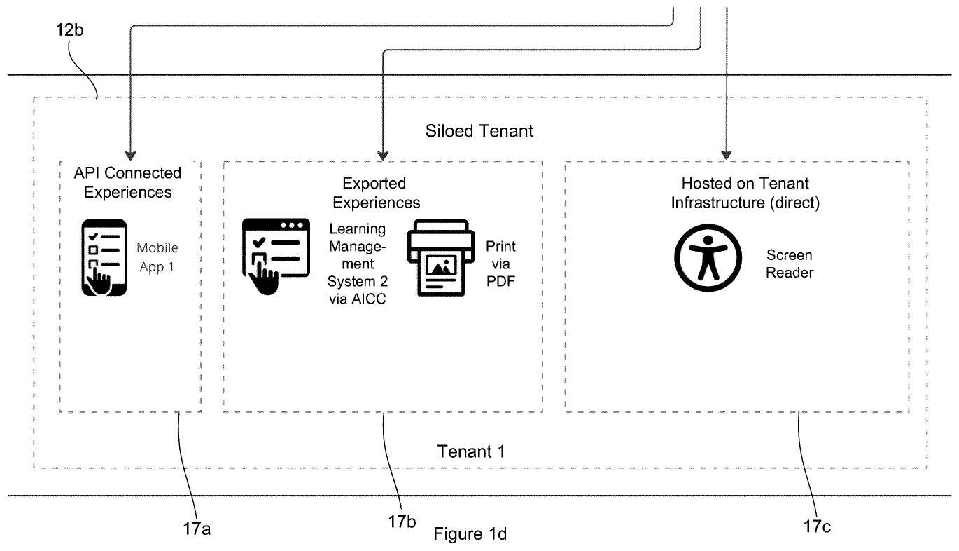

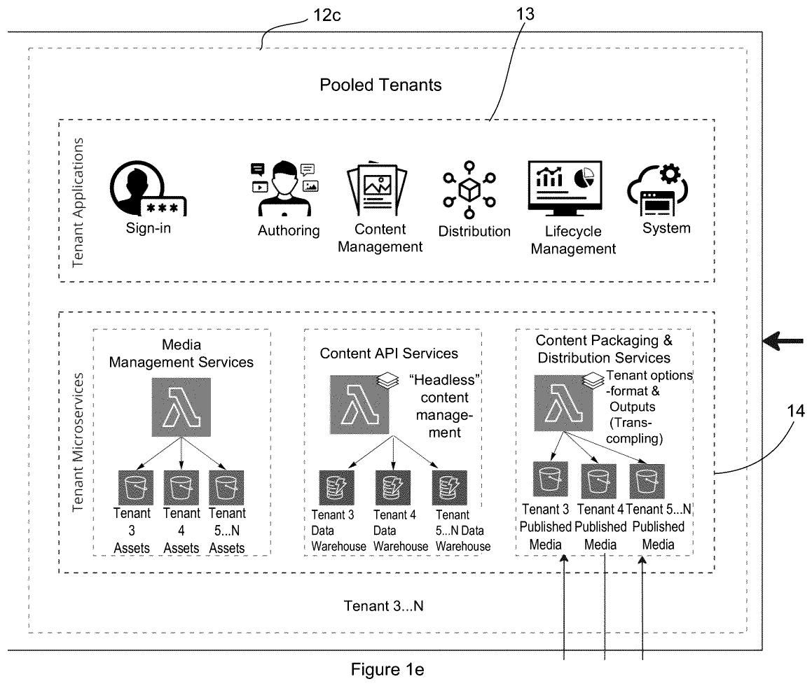

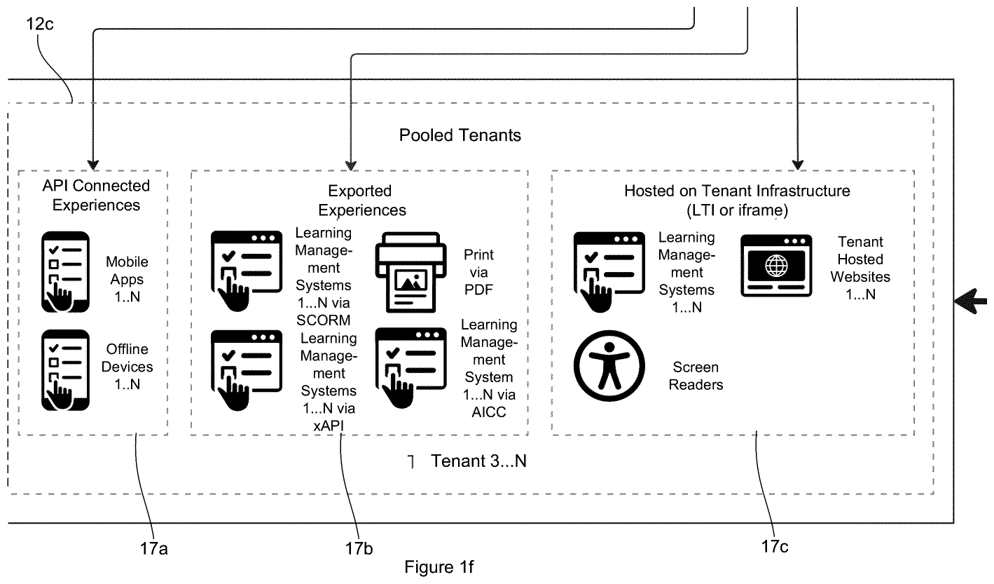

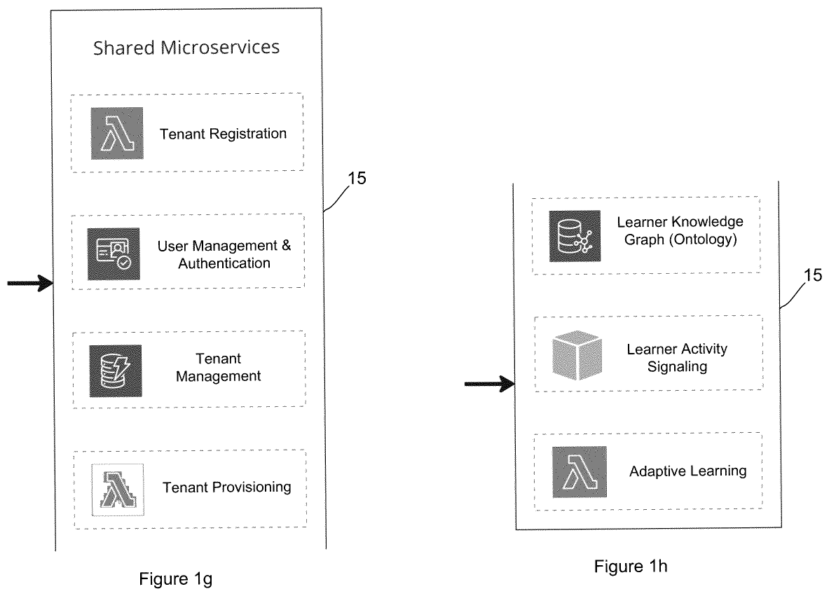

In FIG. 1, there is shown a system 10 for authoring, publishing, versioning, managing and distributing e-learning content across multiple learning environments. The system 10 comprises a tenant infrastructure 11 representing two types of tenants; siloed tenants 12a, 12b, where all applications and tenant microservices are made available explicitly for that tenant's use, and pooled tenants 12c where tenant applications 13 and microservices 14 are shared though the experience is distinct for each tenant 12a-c. Practically, all tenants 12a-c have the same operating experience, the difference between these tenant types reflects an infrastructure differentiation primarily driven by the size of the client and the expected load on the SaaS system.

The tenant microservices 14 serve the functionality required for the tenant specific applications for media management (file management, transcoding, caching, etc.), content management (data warehousing of headless content), and packaging and distribution (transcompiling to the tenant's format, styling, and output requirements). Shared microservices 15 serve both the tenant application 13 and learning environments 16 with functions either not needing to be balanced on load concerns, or where anonymized “big data” shared across tenants can be valuable for all tenants using the system, such as, shared learner data informing numerous tenant experiences. Example shared microservices 15 comprise tenant registration, user management and authentication, tenant management, tenant provisioning, learner knowledge graph (ontology), learner activity signaling and adaptive learning.

In both siloed and pooled tenant cases 12a-c, three types of tenant learner experiences are supported i.e. API connected experiences 17a, exported experiences 16b (the traditional model the industry currently relies on), and hosted experiences 17c on tenant infrastructure. API connected experiences 17a and hosted experiences 17c differ only in the methods necessary to connect a tenant's clients' learning management system, applications, or hosted environments with the tenant's infrastructure for delivering and updating the experiences.

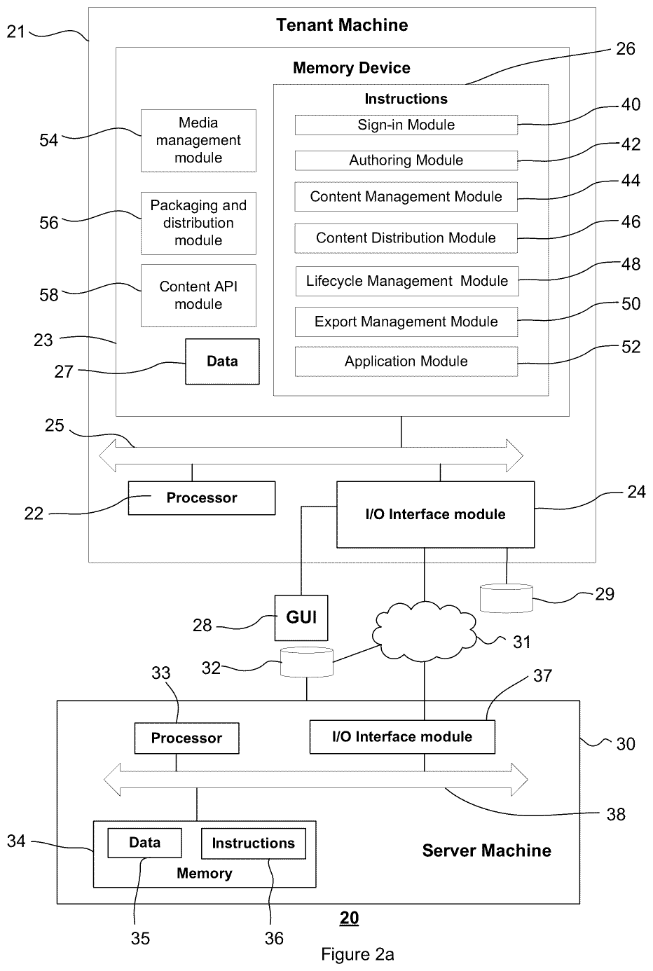

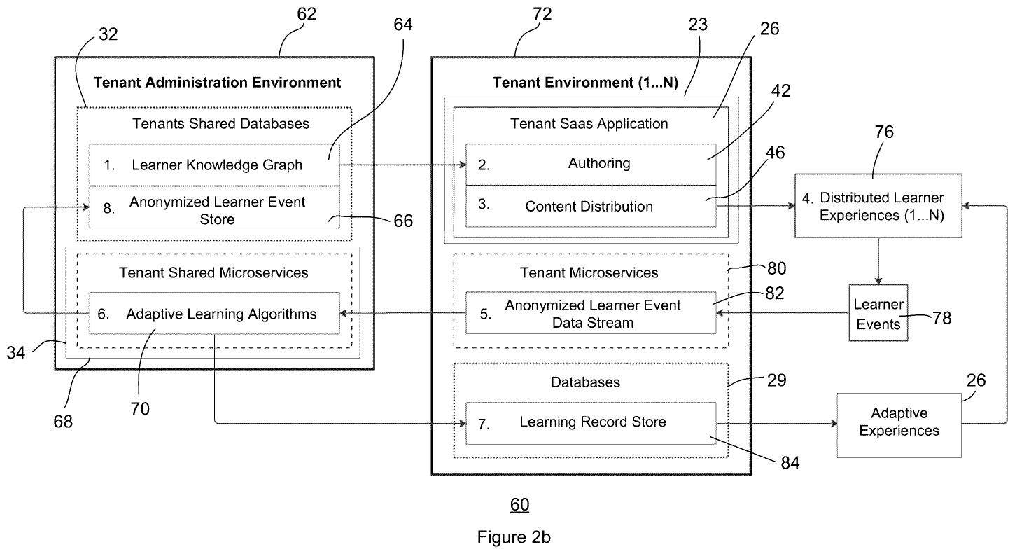

FIG. 2a shows an overall system architecture 20 comprising a client user device 21, or tenant device, with a processor 22, memory device 23 and input/output interface module 24, interconnected by communications bus 25. The client user may be a customer who may be represented as a “tenant” of the system 20, such as a school, college, university, or other educational institution that serves end users, such as students or learners. Tenants have access to tenant applications for publishing, versioning, distributing, and managing the content. In one example, learners consuming the produced content are also restricted to that tenant except when explicit permission to share or move primary data ownership has been approved e.g., when a learner transfers to a new school and therefore switches from one tenant to another tenant.

In one example, memory device 23 is capable of storing machine executable instructions 26, data 27, including data models and process models. Further, the processor 22 is capable of executing the instructions 26 stored in memory device 23 to implement aspects of processes described herein. For example, processor 22 may be embodied as an executor of software instructions 26, wherein the software instructions 26 may specifically configure the processor 22 to perform algorithms and/or operations described herein when the software instructions 26 are executed. Alternatively, the processor 22 may execute hard-coded functionality. Client device 21 also comprises a graphical user interface (GUI) 28 and database 29 are also coupled to tenant user device 21 via I/O interface module 24.

The client device 21 may be communicatively coupled to a server machine 30, such as a SaaS server computer, via a communication network 31. The server machine 30 provides a SaaS application designed to address the publication, versioning, distribution, and remote management needs of e-learning content across multiple learning environments. Coupled to the server machine 30 is one or more shared databases 32 that are shared by the tenants. The one or more shared databases 32 may be communicatively coupled directly to the server machine 30 or via network 31. Similar to client device 21, the server machine 30 comprises one or more processors 33, memory device 34 storing data 35, including data models and process models, and instructions 36, I/O interface module 37, interconnected by communications bus 38.

At the client device 21, instructions 26 stored in memory device 23 comprise several service modules, such as: sign-in module 40; authoring module 42; content management module 44; content distribution module 46; lifecycle management module 48; export management module 50; export management module 50; application management module 52; media management module 54; packaging and distribution module 56; and content API module 58.

Sign-in module 40 comprises an identity and access management (IAM) service for administrators, customers, and applications throughout the tenant system; authoring module 42 for providing a lesson and page builder environment, a discreet editing environment that provides drag and drop and keyboard-based controls for developing content that supports print and digital experiences for the same set of content. Example features of the system include but are not limited to print and digital components that can be used for both print and digital student experiences divided into non-interactive components typically equivalent to HTML elements or small groupings of HTML elements such as, but not limited to headers, paragraphs, and images, and an assessment engine which manages all components and question types related to quizzing, exams, and other assessments of student experiences. Digital only components that can only be used for digital student experiences in view of their interactivity and technology requirements are divided into interactive components typically equivalent to HTML elements or small groupings of HTML elements and associated interaction such as, but not limited to, accordions, tabs, carousels, dynamic tables and iFrames. These components often wrap, nest, or elevate other Print and Digital or Digital Only experiences and may have configuration options for tailoring the expected experiences; interactive learning objects (ILOs) which are interactive components that have been specifically designed around learning outcomes, and enable students to better visually understand and virtually interact with phenomena they learn in the course material, such as, but not limited to, periodic table of elements, environment simulations, and virtual labs; and preset experience library components which are standalone experiences with minimal configuration options such as, but not limited to standalone games which can be included in the curriculum largely “as-is”. Other features of the system associated with the authoring module 42 comprise asset manager 54 which handles uploading, editing, metadata, and inclusion of media such as images and video into the authored experience; collaboration tools for visualizing and managing shared manipulation of content asynchronously or synchronously as the material is built and reviewed. Functionality includes, but is not limited to, visibility of simultaneous user activity, commenting, and review process sharing and management; adaptive learning content management including tagging functionality, knowledge graph use and extension, and content section management.

Sign-in module 40 comprises an identity and access management (IAM) service for administrators, customers, and applications throughout the tenant system; authoring module 42 provides a lesson and page builder environment, a discreet editing environment that may provide drag and drop and keyboard-based controls for developing content that supports print and digital experiences for the same set of content. Example features of the system include but are not limited to print and digital components that can be used for both print and digital student experiences divided into non-interactive components typically equivalent to HTML elements or small groupings of HTML elements such as, but not limited to headers, paragraphs, and images, and an assessment engine which manages all components and question types related to quizzing, exams, and other assessments of student experiences. Digital only components may be used for digital student experiences in view of their interactivity and technology requirements, are divided into interactive components typically equivalent to HTML elements or small groupings of HTML elements and associated interaction such as, but not limited to, accordions, tabs, carousels, dynamic tables and iFrames. These components often wrap, nest, or elevate other Print and Digital or Digital Only experiences and may have configuration options for tailoring the expected experiences; interactive learning objects (ILOs) which are interactive components that have been specifically designed around learning outcomes, and enable students to better visually understand and virtually interact with phenomena they learn in the course material, such as, but not limited to, periodic table of elements, environment simulations, and virtual labs; and preset experience library components which are standalone experiences with minimal configuration options such as, but not limited to standalone games which can be included in the curriculum largely “as-is”. Other features of the system associated with the authoring module 42 comprise asset manager 54 which handles uploading, editing, metadata, and inclusion of media such as images, audio, and video into the authored experience; collaboration tools for visualizing and managing shared manipulation of content asynchronously or synchronously as the material is built and reviewed. Functionality includes, but is not limited to, visibility of simultaneous user activity, commenting, and review process sharing and management; adaptive learning content management including tagging functionality, knowledge graph use and extension, and content section management.

Content management module 44 is responsible for learning content development system for creating, editing, and managing the lessons and supplementary materials for each course package. The system loads the authoring system for each content piece that is being developed and enables the organization and grouping of the resulting materials into a course outline that instructs the packaging of course packages upon publication (“publishing”) of a finalized course. Example features of the authoring system include but are not limited to: a course builder system, an overarching system for creating, editing, and managing courses within the system; a course outlines system for organizing all learning content of a particular course or course instance in preparation for publication; a content repository which stores content produced within the authoring system as headless content which is content that is described independently from its presentation layer save for reflections of components that were used. For example, but not limited to, a reference to the inclusion of a video as a video ID and platform reference, but no code for producing the appropriate player for that video experience. Also included is a course packaging system for publishing a finalized course into the appropriate formats in preparation for distribution; a catalogue management system for grouping a collection of one or more courses together that can be made available through content distribution module 46 to either other tenants or the public for various uses, such as but not limited to direct registration; version control, a system that tracks and manages all changes within the system, both at a authoring level and within other areas of the content management system; a article builder system, an overarching system for creating, editing, and managing all content produced by the system that is not a course, such as but not limited to knowledge base/help articles and blog posts; the overarching system uses the same authoring system for content management as the course builder, with learning components reduced or suppressed in favour of expanded journalist components.

Content distribution module 46 comprises a system responsible for creating, editing, and managing the distribution of these materials to other tenants or public end points. Some features of the content distribution system 46 include, but are not limited to: reporting and management of how and where the courses are distributed via automated tracking of any “live hosted” experiences; reporting and management of how and where the courses are distributed via manually tracking for any non-“live hosted” experiences; and the systems for managing such distributions, such as but not limited to, sending new live updates or exporting new versions for non-“live hosted” experiences and manually updating distribution details.

Lifecycle management module 48 is a system and environment for the overall tenant SaaS application. Some features of the lifecycle management module 48 include, but are not limited to: a reporting engine for all data related reporting functions of the application, such as but not limited to, systems usage and performance, distribution tracking, learner progression, class progression; notification services for managing user and system notifications both within and outside of the application; an update manager for managing application updates automated or otherwise; federation and access control for managing users, permissions, and groups and for turning on and off features and settings from the system; and security and monitoring for managing security related concerns.

Export management module 50 is system responsible for transcompiling courses and articles to the tenant's format, styling, and output requirements. Some examples of outputs include, but are not limited to: a PDF format for users with limited or no access to devices who are looking for a printable copy of a course; an accessible-first HTML version of a course for users using assistive technology such as a screen reader; an offline version of the course with full digital interactivity enabled for users with limited or no access to the internet but who do have access to a digital device such as a computer or smartphone; a traditional LMS package for administrators looking to upload a static or traditional SCORM (or similar format) package to a LMS for students to study from; a remotely managed LMS package for administrators looking to distribute courses to LMSes that can be updated directly and in real-time from within the platform without the need to upload a new version; and directly hosted standalone experiences, whether public or behind a managed login, which are not dependent on a third party LMS.

Application management module 52 is responsible for the tenant's account related functions such as but not limited to, billing, knowledge base, technical support, account management, third party integrations, theming, licensing, and shared service subscriptions, and permissions.

Media management module 54 comprises the microservices behind the system's asset manager for handling uploading, editing, and metadata of media. Some features of the media management module 54 include, but are not limited to: asset variants from such actions as cropping, colour manipulation etc. that are saved independently from but in direct relationship to the source material; compression and optimization services for reducing and streamlining file sizes and metadata of assets; and services for managing assets between local and remote file systems such as cloud storage providers.

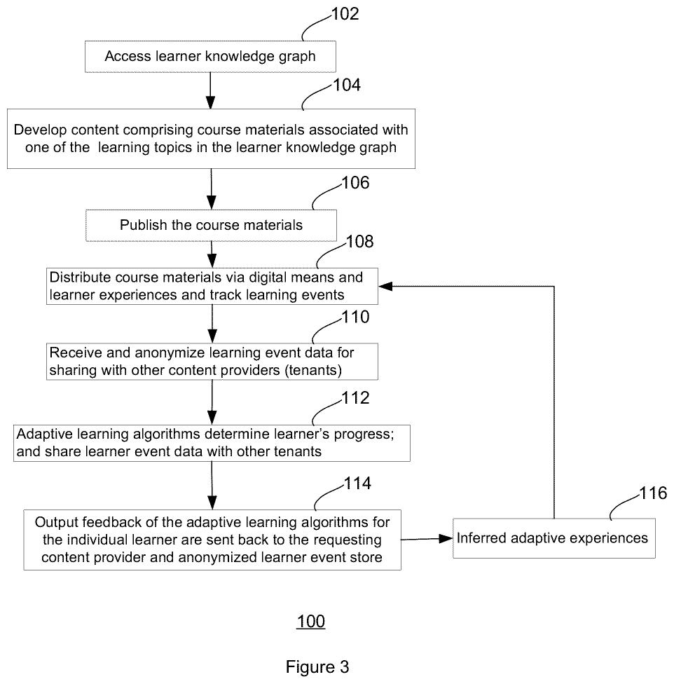

Packaging and distribution module 56 comprises microservices responsible for supporting the course packaging module 44 and content distribution 46 services of the system, as will be described in more detail with reference to FIGS. 3 and 5.

Content API module 58 comprises microservices responsible for transferring data and meaning of the content between the content store of databases and the requesting services.

For example, authoring module 42 provides a suitable user-interface with an authoring environment for building pages for lessons and/or courses. In one example, the authoring environment comprises a discreet editing environment that provides drag and drop and keyboard-based controls for developing content. In one example, the same developed content is suitable for both print and digital experiences. As such, print and digital components that can be used for both print and digital end-user experiences divided into non-interactive components typically equivalent to HTML elements or small groupings of HTML elements such as, but not limited to headers, paragraphs, and images.

The systems and methods are configured to build e-learning experiences that are accessible-first and reflect inclusive-design with minimal additional effort. This is accomplished by biasing the editing experience towards print and accessible-first considerations accompanied by component considerations that are designed for the progressive enhancement of content experiences. Content that is produced in this editing experience is saved in a “headless” format, a format that decouples the presentation of the content from its structure, which enables a method of centralized content management that supports numerous exported experiences. When an author chooses to publish and package their e-learning experience this “headless” content is transcompiled into various formats selected by the author. During transcompilation key aspects of presentation such as the theming/styling of the content and selecting the appropriate technologies for inclusion such as video streaming providers are applied to the content.

In one example, the system export capabilities can be divided into two categories of experiences from a content perspective, such as print-related experiences and digital-related experiences.

Print-related experiences are experiences that are inherently dependent on text as a construct for delivery of the educational experience. These experiences include printed materials which can support individuals who have limited access to devices, such as computers, tablets, or smart phones, and individuals using assistive technologies, such as screen readers.

Digital-related experiences are experiences that are inherently dependent on the text print-related experiences but are also progressively enhanced digitally. These experiences can support individuals with access to devices, such as computers, tablets, or smart phones, who may or may not have consistent access to the internet. For example, in remote communities, individuals may not have access, or at least reliable access to the internet, however they may have access to devices that can present a digital experience. These internet-limited devices can thereby present the digital experience in offline mode. For individuals who have access to devices and reliable internet access several experiences can be supported, such as but not limited to, direct hosted experiences where the individual visits a website or downloads a mobile app and studies within that environment, traditional LMS experiences where the content is uploaded to the LMS and learners study the material within that environment, or live hosted LMS experiences where the learners study the material within their LMS but the content is centrally distributed to them through a hosted experience on the server computer 30.

Example features of the system include but are not limited to print and digital components that can be used for both print and digital student experiences divided into non-interactive components typically equivalent to HTML elements or small groupings of HTML elements such as, but not limited to headers, paragraphs, and images, and an assessment engine which manages all components and question types related to quizzing, exams, and other assessments of student experiences. Digital only components that can only be used for digital student experiences in view of their interactivity and technology requirements are divided into interactive components typically equivalent to HTML elements or small groupings of HTML elements and associated interaction such as, but not limited to, accordions, tabs, carousels, dynamic tables and iFrames. These components often wrap, nest, or elevate other Print and Digital or Digital Only experiences and may have configuration options for tailoring the expected experiences; interactive learning objects (ILOs) which are interactive components that have been specifically designed around learning outcomes, and enable students to better visually understand and virtually interact with phenomena they learn in the course material, such as, but not limited to, periodic table of elements, environment simulations, and virtual labs; and preset experience library components which are standalone experiences with minimal configuration options such as, but not limited to standalone games which can be included in the curriculum largely “as-is”. Other features of the system associated with the authoring module 42 comprise asset manager 54 which handles uploading, editing, metadata, and inclusion of media such as images, audio, and video into the authored experience; collaboration tools for visualizing and managing shared manipulation of content asynchronously or synchronously as the material is built and reviewed. Functionality includes, but is not limited to, visibility of simultaneous user activity, commenting, and review process sharing and management; adaptive learning content management including tagging functionality, knowledge graph use and extension, and content section management.

The courses and articles are transcompiled to the tenant's format, styling, and output requirements. Some examples of outputs include, but are not limited to: a PDF format for users with limited or no access to devices who are looking for a printable copy of a course; an accessible-first HTML version of a course for users using assistive technology such as a screen reader; an offline version of the course with full digital interactivity enabled for users with limited or no access to the internet but who do have access to a digital device such as a computer or smartphone; a traditional LMS package for administrators looking to upload a static or traditional SCORM (or similar format) package to a LMS for students to study from; a remotely managed LMS package for administrators looking to distribute courses to LMSes that can be updated directly and in real-time from within the platform without the need to upload a new version; and directly hosted standalone experiences, whether public or behind a managed login, which are not dependent on a third party LMS.

The format, method and technological requirements to fulfill an experience type include, but are not limited to: Print for PDF; Print for Braille; Screen Readers via media-less/text only HTML5; LMSes via traditional learning technology interoperability standard packages such as SCORM/AICC/xAPI which contain full course materials (the industry standard method); LMSes via “remote 1 ms packages” using a technique to use traditional learning technology interoperability standard packages such as SCORM/AICC/xAPI as a vehicle to distribute iFramed and learning tools interoperability (LTI) enabled content which remotely reference full course materials; LMSes via “remotely managed” content where the system builds and updates the iFramed and LTI enabled content dynamically using the LMS's APIs while maintaining ongoing and active management of the content centrally; and Mobile apps or website experiences without a LMS via direct hosting of APIs, HTML5 and similar technologies.

It is to be appreciated that the particular arrangement of modules 40-58 illustrated in FIG. 2a embodiment is presented by way of example only, and alternative arrangements can be used in other embodiments. For example, the functionality associated with the modules 40-58 in other embodiments can be combined into a single module, or separated across a larger number of modules. As another example, multiple distinct processors 22 can be used to implement different ones of the modules 40-58 or portions thereof. At least portions of the modules 40-58 may be implemented at least in part in the form of software comprising program code 26 stored in memory device 23 and executed by processor 22.

In one example, it is assumed that a tenant user associated with one or more of the client devices 21 is attempting to access services and applications on a server machine 30 over the network 31, and that access to the services requires successful tenant user authentication to the server machine 30. As such, the server machine 30 may include an authentication server running an identity and access management (IAM) service for users, such as administrators, customers, and applications throughout the tenant system.

The authentication or validation process begins with the tenant user entering login credentials on a user-interface 28 presented on a display associated with the tenant user device 21 and provided by a web server at the server machine 30. In an operation, the tenant user enters identification information that may include a user ID and a password. First time users may be required to provide personal information and to select the user ID and/or the password before being allowed to continue. The user submits the identification information to the server machine 30. A test is implemented in an operation to determine if the identification information authenticates the tenant user. For example, if the submitted user identification information matches the information stored in a database for a known valid user of the service, the user is authenticated. If not, the user is redirected back to the login user interface or to an error page and may try to log in again. If the user is successfully authenticated, the tenant user is provided access to the service provided at the server machine 30.

Looking at FIG. 2b, there is shown a tenant (or content producer) real-time adaptive learning infrastructure 60 associated with the server machine 31, comprising a tenants administration environment 62, centrally-hosted tenants shared databases 32 comprising a learner knowledge graph 64 and anonymized learner event data store 66, and instructions 36 stored in memory device 34 and comprising tenants shared microservices 68 and adaptive learning algorithms 70 executable by processor 33.

At the tenant device 21, tenant environment 72 comprises memory device 23 with instructions 26 executable by the processor 33 to provide a tenant SaaS application 74 with authoring module 42 for developing content and content distribution module 46 for distributing the content to learners associated with various learner experiences 76 (e.g.,. LMSes, directly on the web, or via mobile apps) which generates learner events 78. Also stored in memory device 23 are processor-executable instructions such as tenant microservices 80 which anonymize learner event data 82 derived from learner events 78, as will be described in more detail below. The tenant environment 72 also comprises one or more databases comprising learning record store 84 which outputs the outcome of the adaptive learning algorithms 70. Inferred adaptive experiences 26 are fed back to the learner experiences 76 to refine the course materials and learning of same.

Looking at FIG. 3, there is shown a flow chart 100 outlining example steps for real-time adaptive learning, in which a tenant (or content producer) develops adaptive e-learning experiences for a plurality of learners.

Starting in step 102, the tenant user accesses one more tenant shared databases 32 with a learner knowledge graph 64 comprising a centrally hosted graph database with the defined ontology (dictionary) for all learning topics that are shared by all tenants of the system. Generally, the graph database stores nodes and relationships instead of tables, or documents, such that the data is stored without restricting it to a pre-defined model which results in flexibility in the use of the data. Example graph data points include, but are not limited to: a universally unique identifier (UUID) for each unique learning topic; a learning topic label that provides the real world context for authors to categorize their content; node relationships that describe cross-dependencies of related learning topics; prior learning topics (also known as prerequisites) for formalized dependencies within the node relationships; and adaptive learning variables related to the learning topic, such as, but not limited to, knowledge component (KC) Init values necessary to more effectively run Bayesian Knowledge Tracing (BKT) algorithms.

In step 104, the course materials are developed within an authoring application 42 of the tenant, and each section of content that is associated with learning outcomes is tagged or associated with a learning topic that directly references the topic within the learner knowledge graph. The authoring application 42 allows the tenant to navigate and select the appropriate learning topic for a section of content and assessments. Preferably, any content in the system can only have one learning topic attached to it.

Next, in step 106, the tenant packages the content into the course materials, publishes and distributes the course materials via a course distribution application 46, and the content within each learning section is tagged with the learning topic for all appropriate user interaction.

In step 108, each course that is published may be distributed through numerous digital means and learner experiences for each Tenant's version of that course, such as via learning management systems, directly on the web, or via mobile apps. The learner viewing and interaction activities related to content consumption and learner validation activities such as completing practice questions, quiz/assessment progress and completion, consumption habits, and user/usability feedback are tracked. These activities represent learning events 78 which are used to calculate learner progression.

In step 110, any learner on any learner experience for any tenant distribution shares the same set of learning events for the course material being studied. In one example, while each tenant will have their own respective learning content, the sharing of centralized learning topics guarantees that learners studying a “Math 9” course that includes content on the “basics of quadratics” with tenant A, would have comparable to content for tenant B who cover similar material in a “Math 10” course that includes content on the “basics of quadratics”. Effectively, learning insights may be shared across learners of both tenants A and B. Accordingly, the more tenants that have content with the same learning topics, the higher the collective volume of learners, and the greater the size of the learner event data which can be used to train the adaptive learning models. These learner events will be passed to the tenant environment's microservices 80 which manage the learner event data stream 82 for their own learners. These microservices 80 also anonymize the learner event data prior to sharing the data with other tenants, thereby by enhancing privacy of the individual students or learners, including tenants.

In step 112, a centrally shared set of adaptive learning algorithms 70 and their associated microservices 68 are run on each event that is received from each tenant during a learner's experience. For example, when a quiz question is answered the details of the interaction (correct or incorrect) are anonymized and sent to the shared tenant microservices to determine that learner's progress. As such, as the learners engage with the content, events of interests are sent to an event processor which sanitizes the event by assigning it an anonymized learner UUID that remains associated with the tenant and standardizes the format of the learner event data. Sanitizing this activity at the point of origin enables the tenant to track and make requests against their learners while sharing the event data anonymously with other tenants.

In step 114, the results of the adaptive learning algorithms for the individual learner are sent back to the calling tenant; and simultaneously, the anonymized event data and results of the adaptive learning algorithms are sent to an anonymized learner event store 66, and in step 116, the inferred adaptive experiences are fed back to step 108.

Newly anonymized requests are then sent to a learner event data stream processor, and the key data points include, but are not limited to: the learner topic UUID for relating the event to the appropriate centralized learning topic; the anonymized learner UUID for enabling the learner's tenant to make learner tracking requests; the learning event representing standardized labels of activity for categorization, reporting, and determining the appropriate processing for such events; additional details of the event, such as in the case of an assessment event (quiz question answered), was the response indicative of a successful answer or a failure to correctly answer; and tracking mechanisms or status indicators regarding the post processing of the event.

In addition to the activities associated with the processing of an active event (steps 102-114), the methods and systems support direct requests of the system to provide details on a learner. This is typically called at an appropriate time in the learning experience as a means of initiating an adaptive experience that was not tied to an input event (such as a learner opt-in request for further assistance). This type of learner status request directly calls the adaptive learning managing processing scripts, which would return the learner scores from the anonymized learner data warehouse.

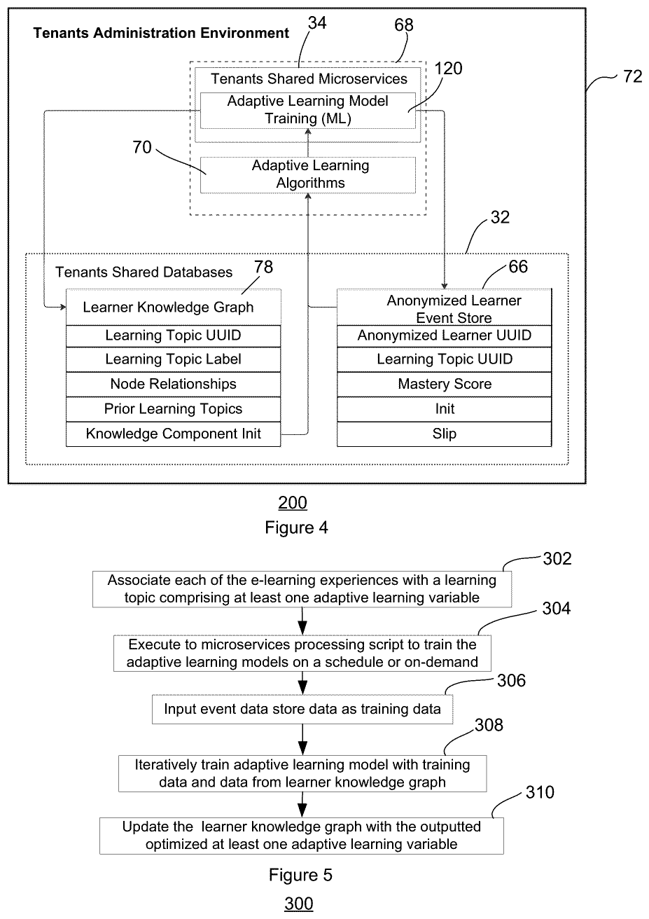

The insights derived from the larger data set would then be processed and any optimization opportunities sent back to the originating learner knowledge graph database for improving the performance of the system. For example, in the case of BKT, one area of opportunity is to refine the Knowledge Component init value for each learning topic. As such, the central store allows for safe algorithm refinement against all learners use across all tenants, as described further with reference to FIGS. 4 and 5.

In FIG. 4, there is shown a tenants scheduled adaptive learning model training infrastructure 200 with tenant administration environment 62 comprising processor-executable instructions 36 stored in memory device 34 and comprising tenants shared microservices 68 and adaptive learning models 120 comprising adaptive learning algorithms 70. The tenant administration environment 62 also comprises one or more tenants shared databases 32 comprising learner knowledge graph 78 and anonymized learner event store 66.

In FIG. 5, there is shown a flow chart 300 outlining example steps for training adaptive learning models using tenant real-time adaptive learning infrastructure 200. Generally, the data processes and workflow are comprised of the following steps: a processing script responsible for running machine learning to train the adaptive learning models is triggered on a regular schedule or on-demand; all applicable learner event data and scoring data across all tenants is retrieved from the data warehouse, and this large data set is used to train the various adaptive learning algorithms that are available at the time.

In step 302, each of the e-learning experiences associated with a learning topic comprising one or more adaptive learning variable.

In step 304, programmed instructions, such as a microservices processing script, are executed to train the adaptive learning models on a schedule or on-demand.

In step 306, a full set of data of the anonymized learner event store 66, representing all learner activity across all tenants of the system is input as training data for the adaptive learning model. The event data store 84 includes results from the live run of the algorithms at the time of the event, for example in the case of a Bayesian Knowledge Tracing (BKT) algorithm run event the following would be example data points captured. By way of example, the anonymized event data store 66 comprises at least: the anonymized learner UUID for enabling the learner's tenant to make learner tracking requests; the learner topic UUID for relating the event to the appropriate centralized learning topic; a mastery score that indicates the progress towards learner topic mastering; an init value which indicates the initial mastery state assigned to the learner prior to commencement of learning; and a slip value to address the risk of a failure to correctly answer from forgetting the learning. The actual data stored would be reflective of the specific algorithm requirements of any given event.

In step 308, the data from the anonymized event data store 66, as well as any relevant data pulled from the learner knowledge graph 64 such as inclusion of prior results and optimizations, is used to train the adaptive learner algorithms.

In step 310, following each iteration, the learner knowledge graph 66 is updated with the appropriate algorithm variables output. Data stored in the learner knowledge graph 66 comprises a learning topic universally unique identifier (UUID) to the system for each unique learning topic; a learning topic label that provides the real-world context for authors to categorize their content; a node relationships that describe cross dependencies of related learning topics; prior learning topics (also known as prerequisites) for formalized dependencies within the node relationships; and adaptive learning variables related to the learning topic, such as but not limited to in the case of a Bayesian Knowledge Tracing (BKT) algorithm where one or more knowledge component Inits unique to the learning topic term will be saved. These values will indicate the algorithm's expected user initial mastery state that would be assigned prior to a commencement of learning in calculating learner progression. As such, the insights derived from the larger data set is then processed and any optimization opportunities sent back to the originating learner knowledge graph database 64 for improving the performance of the system. For example, in the case of BKT, the knowledge component init value for each learning topic may be refined with each iteration.

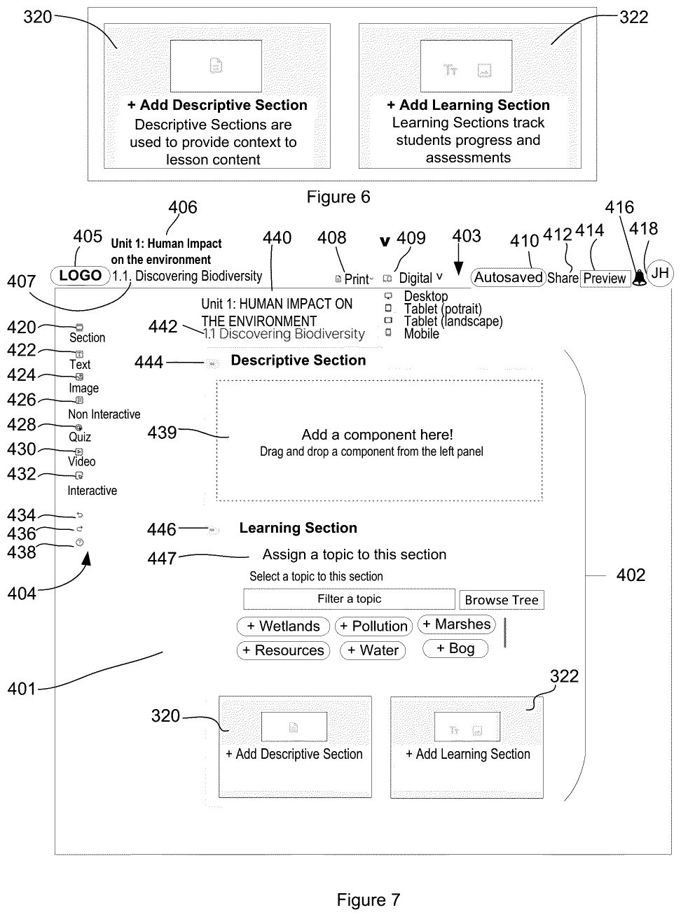

One consideration of the effectiveness of the method or system is the need to drastically reduce the overhead and complexity of assigning learning topics to content. As shown in FIG. 6, the topmost elements within the authoring canvas may be either a descriptive section 320 or a learning section 322, though additional section types may be supported in the future.

Descriptive sections 320 are intended to provide context for the lesson content, typical examples include instructions on how to navigate a lesson, introductory paragraphs that are not intended for learning, and concluding or summary content without learning objectives.

Learning sections 322 are intended to track student progress and assessments. Learning sections 322 comprise the assignment of and limitation of the tenant user to a single learning topic before adding components and other content to the section. All content within a learning section inherits the learning topic from that section and therefore no further metadata entry is needed by the author to assign learning topics, thereby drastically reducing the overhead to enable and actively support adaptive learning expectations. For example, if an author added an opening paragraph, a video explainer, two more paragraphs, and a quiz composed of five questions to a learning section within a lesson then, all nine of these elements would automatically be classified with the same learning topic as the section.

Looking at FIG. 7, an author is presented with user-interface 400 comprising an authoring area or canvas 401 comprising content 402, a top bar 403 and a components tool bar 404. The top bar 403 comprises the following tools or elements, or a sub-set or superset thereof: logo 405 associated with the tenant user, title and/or subtitle 406 of the content 402, print view button 407 which allows the user to view a print version of the content 402, digital view button 408 which allows the author to view a digital version of the content 402, autosave notification 410, share button 412, preview button 414, notification component 416 and author identification 418. The components tool bar 404 comprises the following components or content elements, or a subset or superset thereof: section component 420, formatted text paragraph component 422, image component 424, non-interactive component 426, quiz component 428, video component 430, interactive component 432, undo icon 434, redo icon 436 and query icon 438.

The content 402 within the authoring canvas 401 comprises a unit title 440, a title 442, a descriptive section 444 and a learning section 446. Additional descriptive sections may be added to content 402 by actuating an “Add Descriptive Section” dialog box 320, and learning sections which track student progress and assessments may be added to content 402 by actuating “Add Learning Section” dialog box 320.

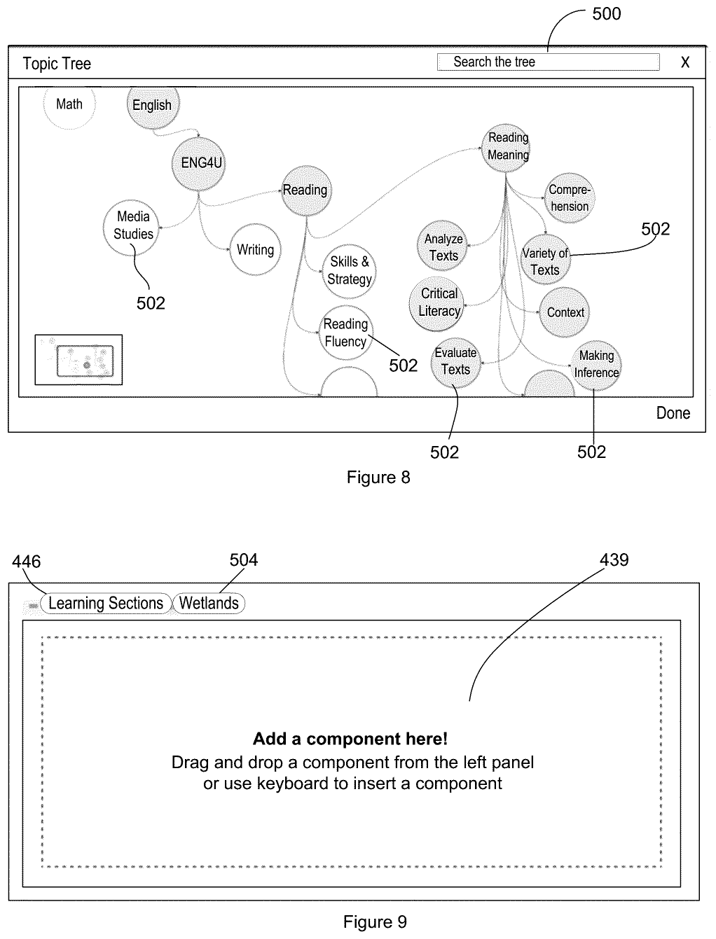

As FIG. 7 indicates, when adding a descriptive section 320 to the lesson on the authoring canvas 401, the user is prompted to insert a component 420-430 into box 439. This action is in contrast with learning sections 322 where a topic selection 447 is required prior to being permitted to add components 420-432 to descriptive section 320. The topic selection offers search and topic recommendations to the author for their convenience, but also provides a “browse tree” option 500, as shown in FIG. 8, which allows for the navigation and selection of any learning topic 502 within the ontology of the centrally shared knowledge graph.

As shown in FIG. 9, once a learning topic 502 is selected, the learning topic label 504 display on the section title bar. This selection may be replaced with a new learning topic 502 at any time; however no learning section 444 can exist without a learning topic 502 being selected. Once a learning topic 502 is selected the learning section 446 behaves exactly like a descriptive section 444 including immediately allowing authors to add components 420-430 to the authoring canvas 401.

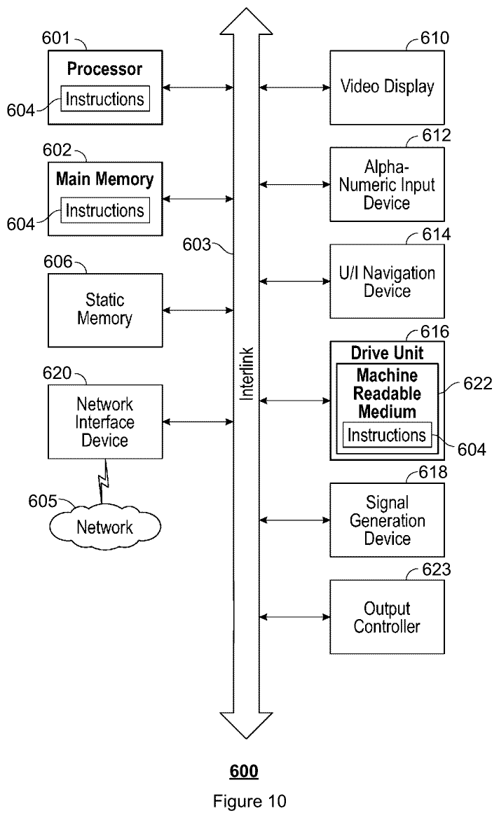

FIG. 10 illustrates a block diagram of an example machine 600, such as client device 21 or server computer 30, upon which any one or more of the techniques (e.g., methodologies) discussed herein may be performed. Machine 600 (e.g., computer system) may include a hardware processor 601 (e.g., a central processing unit (CPU), a graphics processing unit (GPU), a hardware processor core, or any combination thereof), a main memory 602 and a static memory 606, connected via an interlink 603 (e.g., link or bus), as some or all of these components may constitute hardware for systems or related implementations discussed above.

Generally, the hardware processor 601 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 602 include Random Access Memory (RAM), and semiconductor memory devices, which may include storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 21, 30 may further include a display device 610, an input device 612 (e.g., a keyboard), and a user interface (UI) navigation device 614 (e.g., a mouse). In an example, the display device 610, input device 612, and UI navigation device 614 may be a touch-screen display. The machine 21, 30 may include a mass storage device 616 (e.g., drive unit), a signal generation device 618 (e.g., a speaker), a network interface device 620. The machine 21, 30 may include an output controller 723, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 616 may comprise a machine-readable medium 622 on which is stored one or more sets of data structures or instructions 604 (e.g., software) embodying or utilized by any one or more of the techniques or functions described herein.

The instructions 604 may also reside, completely or at least partially, within the main memory 602, within static memory 606, or within the hardware processor 601 during execution thereof by the machine 21, 30. In an example, one or any combination of the hardware processor 601, the main memory 602, the static memory 606, or the mass storage device 616 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 604.

The term “machine readable medium” includes, for example, any medium that is capable of storing, encoding, or carrying instructions for execution by the machine 21, 30 and that cause the machine 21, 30 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 604 may be transmitted or received, for example, over a communications network 605 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 620 includes one or more physical jacks (e.g., Ethernet, coaxial, or other interconnection) or one or more antennas to access the communications network 605. In an example, the network interface device 620 includes one or more antennas to wirelessly communicate using at least one of single-input multiple-output (SIMO), multiple-input multiple-output (MIMO), or multiple-input single-output (MISO) techniques. In some examples, the network interface device 620 wirelessly communicates using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, can include, or can operate on, logic or a number of components, modules, or mechanisms (all referred to hereinafter as “modules”). Modules are tangible entities (e.g., hardware) capable of performing specified operations and is configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a module that operates to perform specified operations. In an example, the software can reside on a non-transitory computer readable storage medium or other machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a GPU, an FPGA, or an ASIC.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communications network 605.

### Various Notes

Each of the non-limiting aspects in this document can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A system configured for at least one content producer to generate adaptive e-learning experiences for a plurality of learners, the system comprising:
at least one memory device configured for storing instructions; and
at least one processor coupled to the at least one memory device and configured to execute the instructions to at least:
access a graph database storing a learner knowledge graph comprising an ontology for a plurality of learning topics;
develop content comprising at least one course material associated with one of the plurality of learning topics, wherein the content comprises a learning section; and wherein the content is associated with at least one learner experience type;
distribute the at least one course material in accordance with a selected e-learning experience, wherein the content within each learning section is tagged with one of the plurality of learning topics suited for the e-learning experience;
track learning events generated by the plurality of learner, wherein the learning events comprise at least one of viewing and interaction activities related to content consumption and learner validation activities;
generate learner event data from the learning events;
anonymize the learner event data;
share the learner event data with another at least one content producer;
based on the learner event data, determine an effectiveness quotient of the content for teaching the course material.

2. The system of claim 1, wherein the graph database is a centrally hosted solution, and ontology for a plurality of learning topics is shared among each of the at least one content producer.

3. The system of claim 2, wherein the instructions comprise a set of instructions executable by the processor to determine at least one of the plurality of learners' progress based on the learner event data.

4. The system of claim 3, wherein the set of instructions comprises adaptive learning algorithms.

5. The system of claim 4, wherein an output feedback of the adaptive learning algorithms is received by the at least one service provider, and the at least one service provider uses the output feedback to refine the content.

6. The system of claim 1, wherein the at least one learner experience type is suitable for a learner environment comprising at least one of print, screen readers, learning management systems, mobile apps, and directly hosted web.

7. The system of claim 3, wherein the at least one learner experience type comprises at least one of Print for PDF; Print for Braille; Screen Readers via media-less/text only HTML5; LMSes via traditional learning technology interoperability standard packages such as SCORM/AICC/xAPI which contain full course materials (the industry standard method); LMSes via “remote lms packages” using a technique to use traditional learning technology interoperability standard packages such as SCORM/AICC/xAPI as a vehicle to distribute iFramed and LTI enabled content which remotely reference full course materials; LMSes via “remotely managed” content where the system builds and updates the iFramed and LTI enabled content dynamically using the LMS's APIs while maintaining ongoing and active management of the content centrally; and Mobile apps or website experiences without a LMS via direct hosting of APIs, HTML5 and similar technologies.

8. A method for generating adaptive e-learning experiences for a plurality of learners by at least one content producer, with a processor coupled to at least one memory device storing instructions executable by the processor to at least perform the operations of:
accessing a graph database storing a learner knowledge graph comprising an ontology for a plurality of learning topics;
developing content comprising at least one course material associated with one of the plurality of learning topics, wherein the content comprises a learning section; and wherein the content is associated with at least one learner experience type;
distributing the at least one course material in accordance with a selected e-learning experience, wherein the content within each learning section is tagged with one of the plurality of learning topics suited for the e-learning experience;
tracking learning events generated by the plurality of learner, wherein the learning events comprise at least one of viewing and interaction activities related to content consumption and learner validation activities;
generating learner event data from the learning events;
anonymizing the learner event data;
sharing the learner event data with another at least one content producer;
based on the learner event data, determining an effectiveness quotient of the content for teaching the course material.

9. At a content producer, a computer readable medium storing instructions executable by a processor to generate adaptive e-learning experiences for a plurality of learners, wherein the instructions carry out the operations comprising:
accessing a graph database storing a learner knowledge graph comprising an ontology for a plurality of learning topics;
developing content comprising at least one course material associated with one of the plurality of learning topics, wherein the content comprises a learning section; and wherein the content is associated with at least one learner experience type;
distributing the at least one course material in accordance with a selected e-learning experience, wherein the content within each learning section is tagged with one of the plurality of learning topics suited for the e-learning experience;
tracking learning events generated by the plurality of learner, wherein the learning events comprise at least one of viewing and interaction activities related to content consumption and learner validation activities;
generating learner event data from the learning events;
anonymizing the learner event data;
sharing the learner event data with at least another content producer;
based on the learner event data, determining an effectiveness quotient of the content for teaching the course material.

10. A method for generating adaptive e-learning experiences for a plurality of learners by at least one content producer, comprising with a processor coupled to at least one memory device storing instructions executable by the processor to at least perform the operations of:
associating each of the e-learning experiences with a learning topic comprising at least one adaptive learning variable;
executing a first set of instructions to train an adaptive learning model on a schedule or on-demand;
inputting anonymized learner event data, scoring data and learner knowledge graph from the at least one content producer as training data;
training the adaptive learning model with the training data to optimize the at least one adaptive learning variable; and
updating the learner knowledge graph with the outputted optimized at least one adaptive learning variable.

11. The method of claim 10, wherein the anonymized event data comprises at least: an anonymized learner universally unique identifier (UUID); a learning topic unique identifier; a mastery score associated with the learner's progress; an init value indicative of the initial mastery state assigned to the learner prior to commencement of learning; and a slip value associated with a risk of a failure to correctly answer due to inability to recall the learning.

12. The method of claim 11, wherein the learner knowledge graph the learning topic universally unique identifier; a learning topic label; node relationships defining cross dependencies of related learning topics; prerequisite learning topics for formalized dependencies within the node relationships; and adaptive learning variables related to the learning topic.
